(19) United States
(12) Patent Application Publication
(10) Pub. No.: US 2021/0056930 A1
(43) Pub. Date: Feb. 25, 2021

(54) ELECTRONIC DISPLAY GAMMA BUS REFERENCE VOLTAGE GENERATOR SYSTEMS AND METHODS

(71) Applicant: Apple Inc., Cupertino, CA (US)

(72) Inventors: Jaeyoung Kang, Palo Alto, CA (US); Jesse Aaron Richmond, San Francisco, CA (US); Mahdi Farrokh Baroughi, Santa Clara, CA (US); Hopil Bae, Palo Alto, CA (US); John T. Wetherell, San Jose, CA (US); Kingsuk Brahma, Mountain View, CA (US); Yuichi Okuda, Saitama-shi (JP); Shingo Hatanaka, San Jose, CA (US); Baris Cagdaser, Sunnyvale, CA (US); Myungjoon Choi, Sunnyvale, CA (US); Jie Won Ryu, Santa Clara, CA (US); Hyunwoo Nho, Palo Alto, CA (US); Yafei Bi, Cupertino, CA (US); Wei H. Yao, Palo Alto, CA (US); Henry C. Jen, Los Altos, CA (US); Derek Keith Shaeffer, Redwood City, CA (US)

(21) Appl. No.: 16/928,882

(22) Filed: Jul. 14, 2020

Related U.S. Application Data
(60) Provisional application No. 62/890,045, filed on Aug. 21, 2019.

(51) Int. Cl. G09G 5/10; G09G 3/20

(52) U.S. Cl. CPC G09G 5/10; G09G 2300/04; G09G 2320/0276; G09G 3/20

(57) ABSTRACT

An electronic device may include an electronic display having multiple display pixels. The display pixels may illuminate at a target luminance based at least in part on a first analog voltage signal. The electronic device may also include an electrical bus configured to generate multiple analog voltage signals including the first analog voltage signal, which is output on an output of the electrical bus. The electrical bus may include a digital to analog converter to generate at least some of the analog voltage signals and multiple output buffers to buffer the analog voltage signals. The outputs may be buffered by an output buffer of the output buffers.

### CROSS-REFERENCE TO RELATED APPLICATIONS

This application claims priority to U.S. Provisional Patent Application No. 62/890,045, entitled “Electronic Display Gamma Bus Reference Voltage Generator Systems And Methods,” filed on Aug. 21, 2019, which is incorporated herein by reference in its entirety for all purposes.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

To display an image, an electronic display generally controls light emission (e.g., luminance and/or color) of its display pixels based on corresponding image data. For example, an image data source may output image data as a stream of image pixels (e.g., pixel data), which each indicates target luminance of a display pixel located at a corresponding pixel position. In some embodiments, image data may indicate target luminance per color component, for example, via red component image data, blue component image data, and green component image data. Additionally or alternatively, image data may indicate target luminance in grayscale (e.g., gray level).

Current may be supplied to the display pixels at various voltage levels generated by a gamma bus to achieve the desired luminance values. In general, a display with a higher resolution (e.g., more display pixels) and/or faster refresh rates (e.g., 60 Hertz, 120 Hertz, 240 Hertz, etc.) may draw more power from a gamma bus, which could cause shifts in the voltage spectrum of the gamma bus when current is sourced from the gamma bus. For example, in some embodiments, the different voltage levels may be achieved via one or more digital to analog converters (DACs), amplifiers, and/or a resistor string, also known as a resistor ladder. As such, when current is sourced from a voltage output of the gamma bus, the voltage level may fluctuate momentarily due to the change in current draw. A reduction in the settling time of this voltage fluctuation may allow for faster refresh rates and help mitigate luminance output artifacts. In one embodiment, using lower resistor values (e.g., on the order of 10 Ohms, 100 Ohms, or 1,000 Ohms) in the resistor string may increase current flow through the resistor string and help reduce the settling time.

Additionally or alternatively, to allow for shorter settling times and/or decrease power consumption, in some embodiments, each voltage output of the gamma bus may include an output buffer, such as an operational amplifier (op-amp). Variations in voltage due to current draw on the voltage outputs, for example due to display pixels drawing on a particular voltage output of the gamma bus, may be reduced by the addition of output buffers on each gamma bus output.

Furthermore, the variation in output impedance amongst the voltage outputs (e.g., based on location in the resistor string) may be reduced or substantially eliminated by using output buffers. For example, by using output buffers, the output impedance of each voltage output may be negligibly affected by the resistor values of the resistor string. As such, output buffers for each gamma bus output may allow for the generated voltage values to have uniform impedance levels (e.g., having less than a 5 percent, less than a 2 percent, and/or less than a 1 percent difference between output impedance of different voltage outputs) and reduce asymmetric shifts in the generated voltage levels due to variations in current draw. Furthermore, in embodiments including a resistor string, the output buffers and reduced impedance levels, may allow for increased resistor values (e.g., on the order of 1,000-100,000 Ohms or greater than 100,000 Ohms) and reduced power consumption of the resistor string and the amplifiers (e.g., tap amplifiers). For example, the increased resistor values may reduce the operating current of the resistor string by 2, 5, 10, or 100 times. Moreover, the increased uniformity may assist in providing more accurate and steady voltage levels to improve the accuracy of the output luminance and image quality.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1, in accordance with an embodiment;

FIG. 3 is another example of the electronic device of FIG. 1, in accordance with an embodiment;

FIG. 4 is another example of the electronic device of FIG. 1, in accordance with an embodiment;

FIG. 5 is another example of the electronic device of FIG. 1, in accordance with an embodiment;

FIG. 6 is a diagrammatic representation of a gamma bus in electrical communication with an electronic display, in accordance with an embodiment;

FIG. 7 is a diagrammatic representation a gamma bus, in accordance with an embodiment;

FIG. 8 is a diagrammatic representation of a gamma bus, in accordance with an embodiment;

FIG. 9 is a diagrammatic representation of a gamma bus, in accordance with an embodiment; and

FIG. 10 is a flowchart of an example process for providing analog reference voltages to an electronic display, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

To facilitate communicating information, electronic devices often use one or more electronic displays to present visual representations of the information via one or more images (e.g., image frames). Such electronic devices may include computers, mobile phones, portable media devices, tablets, televisions, virtual-reality headsets, and vehicle dashboards, among many others. Additionally or alternatively, an electronic display may take the form of a liquid crystal display (LCD), a light emitting diode (LED) display, an organic light emitting diode (OLED) display, a plasma display, or the like.

In any case, to display an image, an electronic display generally controls light emission (e.g., luminance and/or color) of its display pixels based on corresponding image data. For example, an image data source (e.g., memory, an input/output (I/O) port, and/or a communication network) may output image data as a stream of image pixels (e.g., pixel data), which each indicates target luminance of a display pixel located at a corresponding pixel position. In some embodiments, image data may indicate target luminance per color component, for example, via red component image data, blue component image data, and green component image data. Additionally or alternatively, image data may indicate target luminance in grayscale (e.g., gray level).

Digital values of the image data may be mapped to analog voltages to drive each of the display pixels at a target luminance level. In some embodiments, a gamma bus may output multiple different voltage levels corresponding to the digital values of the image data. For example, 8-bit image data may correspond to 256 different luminance levels and, therefore, 256 different voltage levels. As should be appreciated, the image data and corresponding voltage outputs may be associated with any suitable bit-depth depending on implementation and the electronic display. Furthermore, the gamma bus may include more or fewer voltage outputs than the corresponding bit-depth of image data. For example, in some embodiments, the same voltage level may be used for multiple luminance levels, and the current may be pulse-width modulated to obtain the different perceived luminance outputs.

As current is supplied to the display pixels at the various voltage levels generated by the gamma bus, a disparity in output impedance between voltage outputs may lead to non-uniform performance amongst the voltage outputs. Additionally, a gamma bus of a display with a higher resolution (e.g., more display pixels) and/or faster refresh rate (e.g., greater than or equal to 60 Hertz) may draw more power and/or be subject to shifts in the voltage spectrum when current is sourced from the gamma bus to the display pixels. For example, in some embodiments, the different voltage levels may be achieved via a resistor string. When current is sourced to the display pixels from a voltage output of the gamma bus, the voltage level may fluctuate momentarily due to changes in current draw based on how many display pixels are drawing on a particular voltage output of the gamma bus. Lower settling times of this voltage fluctuation may allow for faster refresh rates and help mitigate undesirable luminance output artifacts such as crosstalk between adjacent lines and/or non-uniformity. In one embodiment, lower resistor values (e.g., less than 1,000 Ohms) may increase current flow through the resistor string and help reduce the settling time.

Additionally or alternatively, to help eliminate variations in output impedance, allow for shorter settling times, and/or decrease power consumption, in some embodiments, each voltage output of the gamma bus may include an output buffer, such as an operational amplifier (op-amp). The output buffer may allow for the generated voltage values to have uniform impedance levels over the span of voltage outputs and reduce shifts in the generated voltage levels due to current draw. Furthermore, in embodiments including a resistor string, the reduced impedance levels, may allow for increased resistor values (e.g., on the order of 1,000 Ohms, 10,000 Ohms, 100,000 Ohms, or higher) to reduce power consumption of the resistor string. Moreover, the increased uniformity may assist in providing more accurate and steady voltage levels to improve the accuracy of the output luminance and image quality.

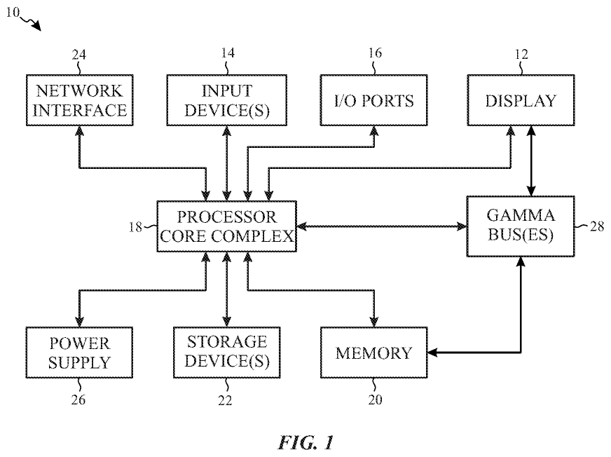

To help illustrate, an electronic device 10, which includes an electronic display 12, is shown in FIG. 1. As will be described in more detail below, the electronic device 10 may be any suitable electronic device 10, such as a computer, a mobile phone, a portable media device, a tablet, a television, a virtual-reality headset, a vehicle dashboard, and the like. Thus, it should be noted that FIG. 1 is merely one example of a particular implementation and is intended to illustrate the types of components that may be present in an electronic device 10.

In the depicted embodiment, the electronic device 10 includes the electronic display 12, one or more input devices 14, one or more input/output (I/O) ports 16, a processor core complex 18 having one or more processor(s) or processor cores, local memory 20, a main memory storage device 22, a network interface 24, a power source 26, and one or more gamma buses 28. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the local memory 20 and the main memory storage device 22 may be included in a single component. Additionally or alternatively, the gamma bus 28 may be included in the electronic display 12.

As depicted, the processor core complex 18 is operably coupled with local memory 20 and the main memory storage device 22. Thus, the processor core complex 18 may execute instruction stored in local memory 20 and/or the main memory storage device 22 to perform operations, such as generating and/or transmitting image data. As such, the processor core complex 18 may include one or more general purpose microprocessors, one or more application specific integrated circuits (ASICs), one or more field programmable logic arrays (FPGAs), or any combination thereof.

In addition to instructions, the local memory 20 and/or the main memory storage device 22 may store data to be processed by the processor core complex 18. Thus, in some embodiments, the local memory 20 and/or the main memory storage device 22 may include one or more tangible, non-transitory, computer-readable mediums. For example, the local memory 20 may include random access memory (RAM) and the main memory storage device 22 may include read only memory (ROM), rewritable non-volatile memory such as flash memory, hard drives, optical discs, and/or the like.

As depicted, the processor core complex 18 is also operably coupled with the network interface 24. In some embodiments, the network interface 24 may facilitate data communication with another electronic device and/or a communication network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, and/or a wide area network (WAN), such as a 4G or LTE cellular network.

Additionally, as depicted, the processor core complex 18 is operably coupled to the power source 26. In some embodiments, the power source 26 may provide electrical power to one or more components in the electronic device 10, such as the processor core complex 18, the electronic display 12, and/or the gamma bus 28. Thus, the power source 26 may include any suitable source of energy, such as a rechargeable lithium polymer (Li-poly) battery and/or an alternating current (AC) power converter.

Furthermore, as depicted, the processor core complex 18 is operably coupled with the one or more I/O ports 16. In some embodiments, I/O ports 16 may enable the electronic device 10 to interface with other electronic devices. For example, when a portable storage device is connected, the I/O port 16 may enable the processor core complex 18 to communicate data with the portable storage device.

As depicted, the electronic device 10 is also operably coupled with the one or more input devices 14. In some embodiments, an input device 14 may facilitate user interaction with the electronic device 10, for example, by receiving user inputs. Thus, an input device 14 may include a button, a keyboard, a mouse, a trackpad, and/or the like. Additionally, in some embodiments, an input device 14 may include touch-sensing components in the electronic display 12. In such embodiments, the touch sensing components may receive user inputs by detecting occurrence and/or position of an object touching the surface of the electronic display 12.

In addition to enabling user inputs, the electronic display 12 may include a display panel with one or more display pixels. The electronic display 12 may control light emission from its display pixels (e.g., via the gamma bus 28) to present visual representations of information, such as a graphical user interface (GUI) of an operating system, an application interface, a still image, or video content, by displaying frames based at least in part on corresponding image data (e.g., image pixel data corresponding to individual pixel positions).

As depicted, the electronic display 12 is operably coupled to the processor core complex 18 and the gamma bus 28. In this manner, the electronic display 12 may display images based at least in part on image data received from an image data source, such as the processor core complex 18 and/or the network interface 24, an input device 14, and/or an I/O port 16. In some embodiments, the image data source may generate source image data to create a digital representation of the image to be displayed. In other words, the image data is generated such that the image view on the electronic display 12 accurately represents the intended image. To facilitate accurately representing an image, image data may be processed before being supplied to the electronic display 12, for example, via a display pipeline implemented in the processor core complex 18 and/or image processing circuitry.

The display pipeline may perform various processing operations, such as spatial dithering, temporal dithering, pixel color-space conversion, luminance determination, luminance optimization, image scaling, and/or the like. Based on the image data from the image data source and/or processed image data from the display pipeline, target luminance values for each display pixel may be determined. Moreover, the target luminance values may be mapped to analog voltage values (e.g., generated by the gamma bus 28), and the analog voltage value corresponding to the target luminance for a display pixel at a particular location may be applied to that display pixel to facilitate the desired luminance output from the display. For example, a first display pixel desired to be at a lower luminance output may have a lower voltage applied than a second display pixel desired to be at a higher luminance output.

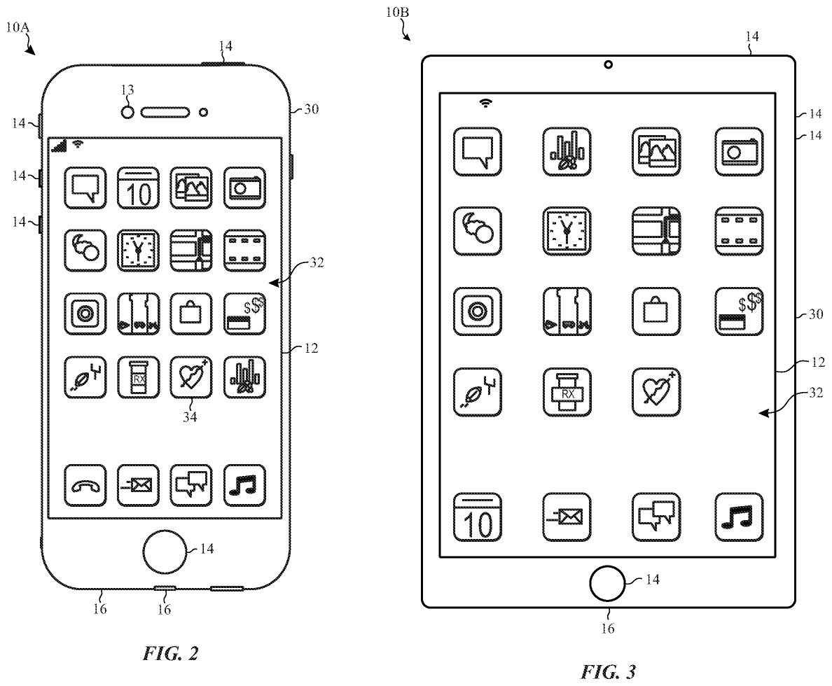

As described above, the electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smart phone, such as any iPhone® model available from Apple Inc.

As depicted, the handheld device 10A includes an enclosure 30 (e.g., housing). In some embodiments, the enclosure 30 may protect interior components from physical damage and/or shield them from electromagnetic interference. Additionally, as depicted, the enclosure may 30 surround the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Furthermore, as depicted, input devices 14 may be accessed through openings in the enclosure 30. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 may be accessed through openings in the enclosure 30. In some embodiments, the I/O ports 16 may include, for example, an audio jack to connect to external devices.

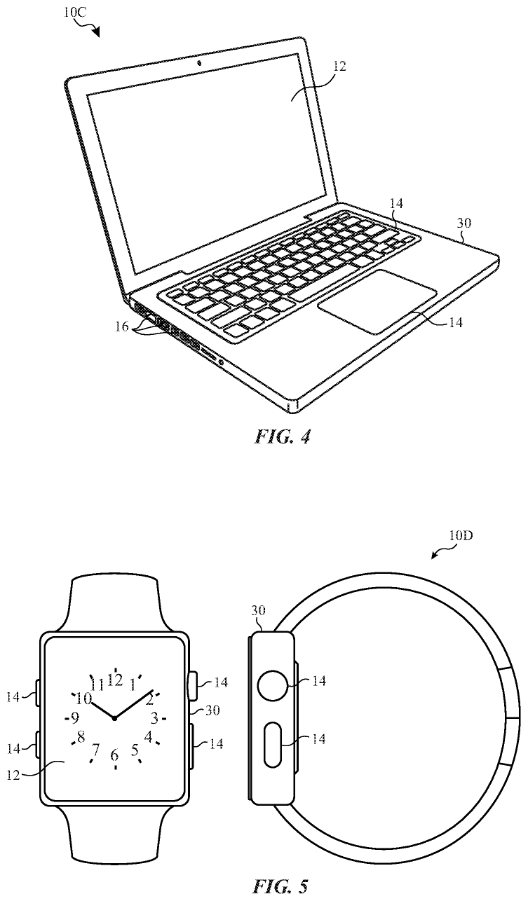

To further illustrate, another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be any Apple Watch® model available from Apple Inc. As depicted, the tablet device 10B, the computer 10C, and the watch 10D each also includes an electronic display 12, input devices 14, I/O ports 16, and an enclosure 30.

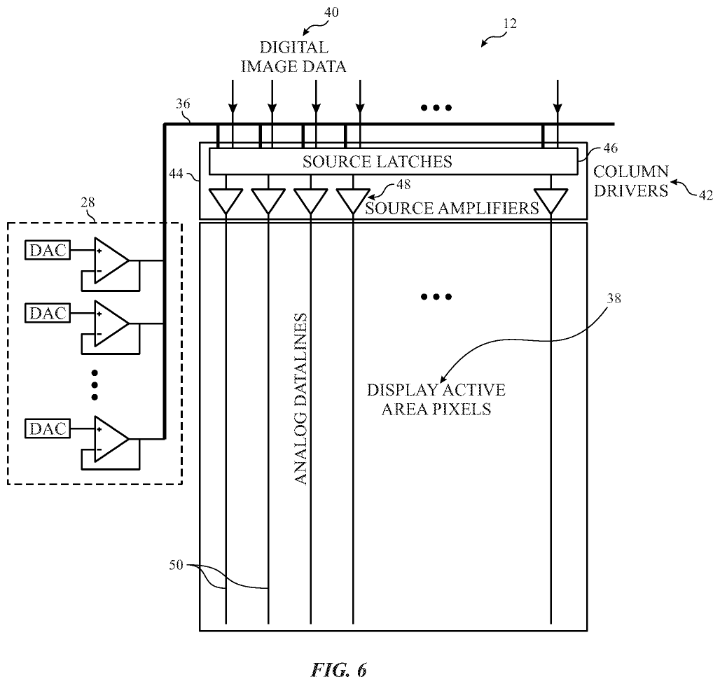

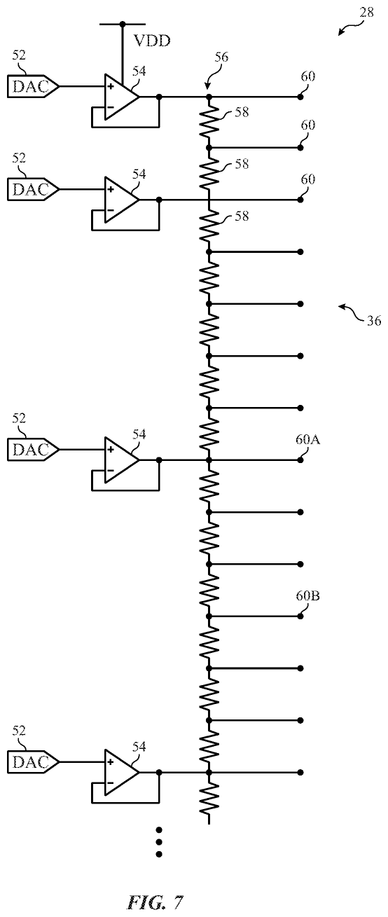

As described above, an electronic device 10 may utilize a gamma bus 28 to provide a spectrum of supply voltages to display pixels to facilitate illumination at a target luminance. To help illustrate, a schematic diagram of a portion of the electronic device 10, including a gamma bus 28 and the electronic display 12 is shown in FIG. 6. As described in more detail below, the electronic device 10 may utilize multiple gamma buses 28, and a single gamma bus 28 is discussed for brevity.

In some embodiments, the electronic display 12 may use analog reference voltages 36 to power display pixels 38 at various voltages that correspond to different luminance levels. For example, digital image data 40 may correspond to original or processed image data and contain target luminance values for each display pixel 38 in an active area of the electronic display 12. Moreover, display circuitry 42, such as the column drivers 44, also known as data drivers and/or display drivers, may include source latches 46, source amplifiers 48, and/or any other suitable logic/circuitry to select the appropriate analog reference voltage 36, based on the digital image data 40, and apply power at that voltage to the display pixel 38 to achieve the target luminance output from the display pixel 38. Power at the appropriate voltage for each display pixel 38 may travel down analog datalines 50 to display pixels 38 of the active area. As should be appreciated, the active area of the electronic display 12 may be all or a portion of the electronic display 12 utilized to display an image.

As discussed above, the different analog reference voltages 36 supplied by the gamma bus 28 may correspond to the values of the digital image data 40. For example, 8-bit digital image data 40 may correspond to 256 different luminance levels and, therefore, 256 different analog reference voltages 36 per color component. For example, digital image data 40 corresponding to 8-bits per color component may yield millions of color combinations as well as define the brightness of the electronic display 12 for a given frame. As should be appreciated, the digital image data 40 and corresponding voltage outputs may be associated with any suitable bit-depth depending on implementation and the electronic display 12 and/or may use any suitable color space (e.g., RBG (red/blue/green), sRBG, Adobe RGB, HSV (hue/saturation/value), YUV (luma/chroma/chroma), Rec. 2020, etc.). Furthermore, the gamma bus 28 may include more or fewer analog reference voltages 36 than the corresponding bit-depth of digital image data 40. For example, in some embodiments, the same voltage level may be used for multiple luminance levels, and the current may be pulse-width modulated to obtain the different perceived luminance outputs. In some embodiments, the gamma bus 28 and/or display circuitry 42 may provide the display pixels with a negative voltage relative to a reference point (e.g., ground). As should be appreciated, the positive and negative voltages may be used in a similar manner to operate the display pixels 38, and they may have mirrored or different mappings between voltage level and target luminance.

Additionally, in some embodiments, different color components of display pixels 38 (e.g., a red sub-pixel, a green sub-pixel, a blue sub-pixel, etc.) may have different mappings between voltage level and target luminance. For example, display pixels 38 of different color components may have different luminance outputs given the same driving voltage. As such, in some embodiments, one or more gamma buses 28 may be used for each color component and/or voltage polarity. As should be appreciated, the mappings between voltage level and target luminance may depend on the type of display pixels (e.g., LCD, LED, OLED, etc.), a brightness setting, a color hue setting, temperature, contrast control, pixel aging, etc., and, therefore, may depend on implementation.

Although the display circuitry 42 may include source amplifiers 48 to drive the display pixels 38 at the analog reference voltages 36, variations in the number of display pixels 38 using a particular analog reference voltage 36 from one frame to the next may vary the current draw on the outputs of the gamma bus 28. To help illustrate, in one embodiment, a gamma bus 28 may include one or more digital to analog converters (DACs) 52, amplifiers 54, and/or a resistor string 56 of multiple resistors 58. The DACs 52 may feed the amplifiers 54 (e.g., tap amplifiers) an adjustable (e.g., via image processing circuitry and/or the processor core complex 18) analog signal to define, in conjunction with the resistor string 56, the voltage level at each output node 60 of the gamma bus 28. The resistor string 56 may interpolate voltage levels between those of the DACs 52 to generate the variety of analog reference voltages 36. Moreover, the resistance values of the resistors 58 may vary along the resistor string 56 to de-lineate the analog reference voltages 36 according to the mapping. As should be appreciated, the mapping may be linear or non-linear depending on implementation. For example, the resistor string 56 may generate linear interpolations to approximate a logarithmic or exponential curve.

In some embodiments, the number of resistors 58 and output nodes 60 along the resistor string 56 may vary (as illustrated) or remain constant between amplifiers 54. Moreover, some output nodes 60 may have larger output impedances and be more sensitive to current draws. For example, an output node 60A closer to an amplifier 54 with respect to the resistor string 56 may have less output impedance than an output node 60B further away from an amplifier 54. Moreover, the variance in voltage level due to current drawn at the close output node 60A may be less than the variance in voltage level at the output node 60B further from the amplifier 54. In general, to help combat such variance, the resistance values of the resistors may be relatively small (e.g., on the order of 10 Ohms, 100 Ohms, or 1,000 Ohms), which may increase current flow through the resistor string 56 and help reduce the variance as well as the settling time.

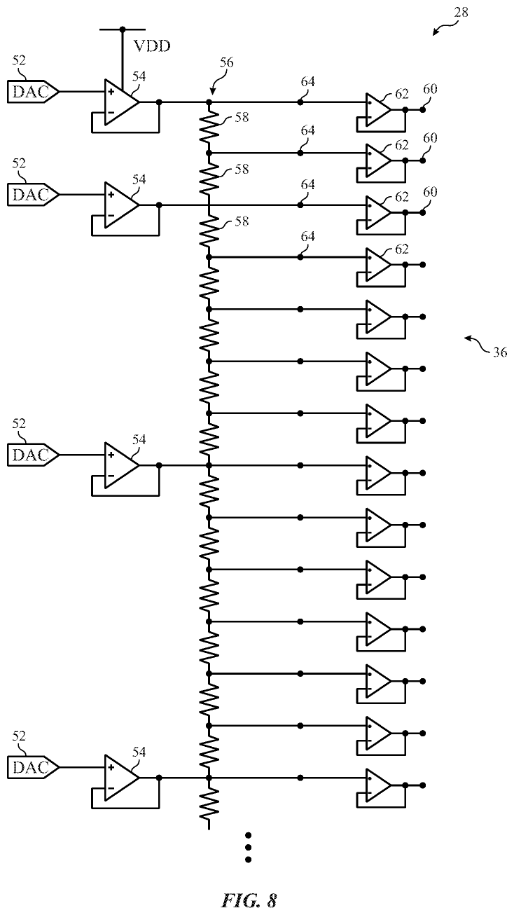

Additionally or alternatively, to help mitigate variations in output impedance, allow for shorter settling times, and/or decrease power consumption, in some embodiments, each analog reference voltage 36 of the gamma bus 28 may be buffered by an output buffer 62, as shown in FIG. 8. In some embodiments, the output buffer 62 may be an operational amplifier (op-amp), low-offset op-amp as discussed in [attorney docket P37344], which is incorporated by reference in its entirety, or other suitable buffer circuitry. The output buffers 62 may allow for the analog reference voltages 36 to have uniform impedance levels, and reduce shifts in the analog reference voltages 36 both at internal nodes 64 and output nodes 60. Moreover, the use of the output buffers 62 may allow the voltage level at the internal nodes 64 to settle much quicker, and, as such, propagate the analog reference voltages 36 with higher precision. Further, the increased precision may lead to smoother and/or more accurate luminance outputs via the display pixels 38.

Furthermore, the output buffers 62 may also reduce the power draw of the resistor string 56. Indeed, the output buffers 62 may source the majority of the current for the analog reference voltages 36 instead of the amplifiers 54 via the resistor string 56. As such, the resistor values may be greatly increased (e.g., on the order of 1,000 Ohms, 10,000 Ohms, 100,000 Ohms or greater than 100,000 Ohms) to reduce power consumption. Moreover, due to the reduced loading on the resistor string 56, the settling time of the resistor string 56 may be reduced. Additionally, the output buffers 62 may decouple the settling time from the accuracy of the amplifiers 54. For example, the output voltages of the amplifier 54 and/or resistor string 56 may remain relatively settled. As such, the amplifier voltages may be optimized for accuracy, power, temperature, or other variable with uniform output impedances, smaller current draws, and reduced voltage variations.

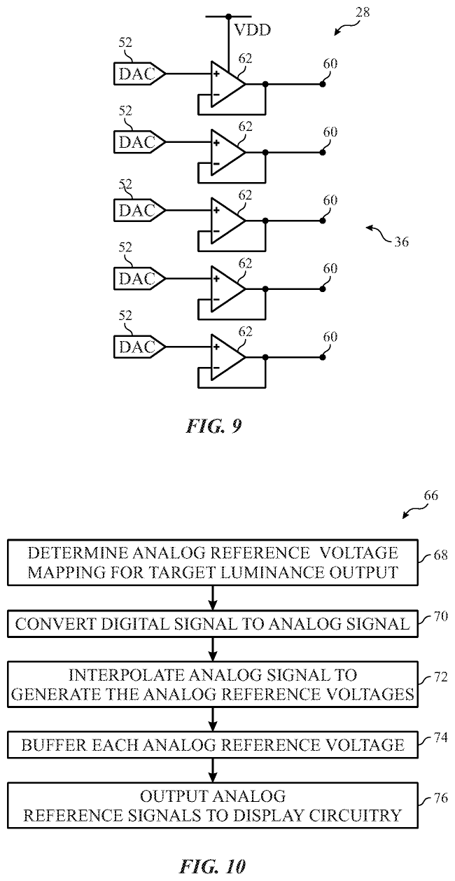

As discussed herein, in some embodiments, each non-zero analog reference voltage 36 may utilize an output buffer 62. Additionally or alternatively, the resistor string 56 may be omitted, and multiple DACs 52 may generate respective analog reference voltage 36 buffered by an output buffer 62, as illustrated in FIG. 9. The output buffer 62 for each analog reference voltage 36 allows for a more uniform impedance and less variation in the analog reference voltage 36. For example, the current draw on the DACs 52 may be relatively small and variation in voltage due to current draw may be reduced. Furthermore, in some embodiments, removing the resistor string 56 may further reduce power consumption.

FIG. 10 is a flowchart 66 of an example process for providing analog reference voltages 36 to an electronic display 12. The mapping between the analog reference voltages 36 and the target luminance output of the display pixels 38 may be determined (process block 68). Additionally, the digital signals for creating the analog reference voltages 36 may be converted to an analog signals, for example via the DACs 52 (process block 70). Further, the analog signals may be interpolated, for example via a resistor string 56 to generate the analog reference voltages 36 (process block 70). Additionally, each analog reference voltage 36 may be buffered, for example, via an output buffer 62 (process block 74). The analog reference voltages 36 may be output to the display circuitry 42 for use in driving the display pixels 38 at target luminance values (process block 76).

As discussed herein, the use of output buffers 62 may allow for faster frame rates (e.g., 60-120 Hertz and/or 60-240 Hertz) and/or higher resolution displays may be accommodated using less power while maintaining increased display uniformity and more accurate luminance levels. Moreover, although the above referenced flowchart 66 is shown in a given order, in certain embodiments, process blocks may be reordered, altered, deleted, and/or occur simultaneously. Additionally, the referenced flowchart 66 is given as an illustrative tool and further decision and process blocks may also be added depending on implementation.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising:
an electronic display comprising a plurality of display pixels, wherein the display pixels are configured to illuminate at a target luminance based at least in part on an analog voltage signal; and
an electrical bus configured to generate a plurality of analog voltage signals, wherein the analog voltage signal is one of the plurality of analog voltage signals and is output on an output of a plurality of outputs of the electrical bus, and wherein the electrical bus comprises:
a digital to analog converter configured to generate at least some of the plurality of analog voltage signals; and
a plurality of output buffers configured to buffer the plurality of analog voltage signals, wherein each of the plurality of outputs is configured to be buffered by an output buffer of the plurality of output buffers.

2. The electronic device of claim 1, wherein the electrical bus comprises a resistor string configured to interpolate the at least some of the plurality of analog voltage signals to generate other analog voltage signals of the plurality of analog voltage signals.

3. The electronic device of claim 2, wherein the resistor string comprises a plurality of resistors, wherein each of the plurality of resistors comprises a resistance greater than or equal to 1,000 Ohms.

4. The electronic device of claim 2, wherein the electrical bus comprises an amplifier between the digital to analog converter and the resistor string.

5. The electronic device of claim 1, wherein the output impedance of each of the plurality of outputs is uniform.

6. The electronic device of claim 1, wherein the electrical bus is one of a plurality of electrical buses, and wherein each electrical bus of the plurality of electrical buses comprises a different mapping between the target luminance to the analog voltage signal.

7. A method comprising:
converting, via first circuitry, a first digital signal corresponding to a first luminance level of a display pixel to a first analog signal, wherein the display pixel is configured to output light at the first luminance level in response to being powered via the first analog signal;
converting, via the first circuitry, a second digital signal corresponding to a second luminance level of the display pixel to a second analog signal, wherein the display pixel is configured to output light at the second luminance level in response to being powered via the second analog signal;
interpolating, via second circuitry, between the first analog signal and the second analog signal to generate a third analog signal, wherein the display pixel is configured to output light at a third luminance level in response to being powered via the third analog signal; and
buffering, via a plurality of output buffers, the first analog signal, the second analog signal, and the third analog signal.

8. The method of claim 7, wherein the first circuitry comprises one or more digital to analog converters.

9. The method of claim 7, wherein the second circuitry comprises a resistor string comprising a plurality of resistors.

10. The method of claim 9, wherein the plurality of output buffers comprises a plurality of operational amplifiers disposed after the resistor string.

11. The method of claim 7, comprising outputting the first analog signal, the second analog signal, and the third analog signal to display circuitry configured to drive the display pixel based at least in part on one of the first analog signal, the second analog signal, and the third analog signal.

12. A gamma bus configured to generate analog reference voltages and output the analog reference voltages to a display driver, wherein the display driver is configured to drive display pixels at particular luminance levels based at least in part on the analog reference voltages, wherein the each of the particular luminance levels corresponds to one analog reference voltage of the analog reference voltages, and wherein the gamma bus comprises a resistor string comprising a plurality of resistors, wherein each of the plurality of resistors comprises a resistance greater than 1,000 Ohms.

13. The gamma bus of claim 12, wherein the resistance of each of the plurality of resistors is greater than 10,000 Ohms.

14. The gamma bus of claim 12, comprising a plurality of output buffers disposed at outputs of the resistor string.

15. The gamma bus of claim 12, wherein the frame-rate of the display driver is greater than or equal to 120 Hertz.

16. An electronic display comprising:
an active area comprising a plurality of display pixels;
a plurality of data drivers configured to drive a respective portion of the plurality of display pixels with a respective driving analog electrical signal; and
a gamma bus configured to provide a plurality of analog electrical signals to the data drivers via a respective plurality of outputs, wherein the plurality of analog electrical signals correspond to possible values of the respective driving analog electrical signals, and wherein each output of the gamma bus has substantially the same output impedance.

17. The electronic display of claim 16, wherein the gamma bus comprises a plurality of output buffers that output the plurality of analog electrical signals, wherein the plurality of output buffers are configured to cause each output of the gamma bus to have substantially the same output impedance.

18. The electronic display of claim 16, wherein the gamma bus comprises:
a digital to analog converter configured to generate at least some of the plurality of analog electrical signals; and
a plurality of output buffers configured to buffer the plurality of analog electrical signals, wherein each output of the gamma bus is configured to be buffered by an output buffer of the plurality of output buffers.

19. The electronic display of claim 18, wherein the gamma bus comprises a resistor string configured to interpolate the at least some of the plurality of analog electrical signals to generate other analog electrical signals of the plurality of analog electrical signals.

20. The electronic display of claim 16, wherein the gamma bus comprises a resistor string that comprises a plurality of resistors, wherein each of the plurality of resistors has a resistance greater than or equal to 10,000 Ohms.
